(19) United States
(12) Patent Application Publication
(10) Pub. No.: US 2025/0131192 A1
(43) Pub. Date: Apr. 24, 2025

(54) Smart Skill Competency Evaluation System

(71) Applicant: Bongo Learn, Inc., Loveland, CO (US)

(72) Inventors: Michael Miller, Fort Collins, CO (US); Brian Scholz, Ormond Beach, FL (US)

(73) Assignee: Bongo Learn, Inc., Loveland, CO (US)

(21) Appl. No.: 18/903,103

(22) Filed: Oct. 1, 2024

Related U.S. Application Data
(60) Provisional application No. 63/544,748, filed on Oct. 18, 2023.

(51) Int. Cl. G06F 40/20

(52) U.S. Cl. CPC G06F 40/20

(57) ABSTRACT

A computing device and methods of making and using a computing device having machine learning capabilities to analyze course text content based on prompting to generate a list of course learning objectives, and in particular embodiments, having machine learning capabilities to analyze presentation content text against each of the course learning objectives to generate a course competency score with supportive reasoning for each course learning objective and an overall presentation score.

This U.S. Non-Provisional patent application claims the benefit of U.S. Provisional Patent Application No. 63/544,748, filed Oct. 18, 2023, hereby incorporated by reference herein.

### I. FIELD OF THE INVENTION

A computing device and methods of making and using a computing device having machine learning capabilities to analyze course text content based on prompting to generate a list of course learning objectives, and in particular embodiments, having machine learning capabilities to analyze presentation content text against each of the course learning objectives to generate a course competency score with supportive reasoning for each course learning objective and an overall presentation score.

### II. BACKGROUND OF THE INVENTION

Today, the use of machine learning (“ML”) is already fairly widespread in education. Machine learning facilitates massive online open courses allowing unlimited participation through the World Wide Web. ML scoring has been integrated to analyze and score essays within coursework assigned by instructors.

However, a gap remains with respect to using ML to assist instructor(s) in generating relevant course learning objectives based on course text content. Accordingly, many instructors, teachers, and administrators continue to rely exclusively on manual assessment of course text content to derive course learning objectives against which student submitted presentation text content can be scored.

Manual review and assessment of course text content and development of course learning objectives based on course text content can be time consuming, variable based on the person performing the assessment of course text content and can lead to inconsistent results across student populations in the evaluation of student submitted presentation text content.

Accordingly, there would be a substantial advantage in using ML, in the first instance, to generate course learning objectives based on course text content, and in the second instance, to use ML to evaluate student submitted presentation text content against each of the ML generated learning objectives. This approach can result in a reduction in time spent by instructors in developing course learning objectives based on course text content and evaluation of student submitted presentation text content and can enhance the accuracy and reliability of scoring student submitted presentation text content against each course learning objective and in overall scoring.

### III. SUMMARY OF THE INVENTION

A language model (“LM”) estimates the probability distribution over text. Recently, scaling improvements through larger model sizes have enabled pre-trained large language models (LLMs) to be adept at certain downstream natural language processing (“NLP”) tasks. Besides the conventional “pre-train and fine-tune” paradigms, certain models can exhibit properties conducive to few-shot learning, where one can use a text or template known as a prompt to guide the generation to output answers for desired tasks, thus allowing for “pre-train and prompt” paradigms. Notably, few-shot learning is taken as a given for tackling chain of thought tasks, and zero-shot baseline performance is rarely reported.

A broad object of particular embodiments of the invention can include a method utilizing a LM with task specific prompting, and in certain embodiments zero-shot template-based prompting, to analyze course text content submitted by an instructor and generate course one or more course learning objectives based on the course text content. In particular embodiments, the method includes analyzing course text content based on analysis prompts under the control of a processor communicatively coupled to a memory containing a machine learning zero-shot algorithm and extracting one or more course learning objectives from the course text content.

Another broad object of particular embodiments of the invention can include a method of utilizing a LM with task specific prompting, and in certain embodiments zero-shot template-based prompting, to analyze student submitted presentation text content against one or more course learning objectives and generating a score for each of the course learning objectives and an overall score. In particular embodiments, the method includes analyzing student submitted presentation text content derived from video or audio transcripts by a processor communicatively coupled to memory containing a machine learning zero-shot algorithm which compares student submitted presentation text content against each of the one or more course learning objectives and generates a competency score justified with one or more supportive reasoning statement(s) and an overall presentation score.

Another broad object of particular embodiments of the invention includes a system including one or more of: a first computing device including a processor communicatively coupled to memory containing a machine learning algorithm using task specific prompting to receive course text content from a user of the first computing device, wherein the machine learning algorithm analyzes the course text content based on analysis prompts input by the user of the first computing device to generate one or more course learning objectives from the course text content, and a second computing device configured to record presentation content produced by user of the second computing device, wherein the first computing device can be further configured to receive the presentation content text from the second computing device, and the machine learning algorithm can further function to analyze presentation content text against each of the one or more course learning objectives to generate a competency score for each of the one or more course learning objectives justified with one or more supportive reasoning statement(s) and an overall presentation score.

Another broad object of particular embodiments of the invention can be to provide a non-transitory computer readable medium encoded with a machine learning algorithm which can use task specific prompts to analyze course text content based on prompts submitted by an instructor to generate one or more course learning objectives for a course. In particular embodiments, the non-transitory computer readable medium encoded with the machine learning algorithm can be prompted to analyze student submitted presentation content against each of the one or more course learning objectives and generate a competency score for each of the one or more course learning objectives justified with one or more supportive reasoning statement(s) and an overall presentation score.

Naturally, further objects of the invention are disclosed throughout other areas of the specification, drawings, photographs, and claims.

### IV. BRIEF DESCRIPTION OF THE DRAWINGS

FIG. 1 is a block diagram of a particular embodiment of the competency evaluation system.

FIG. 2A is a block diagram of a first computing device including a processor communicatively coupled to a non-transitory computer readable media containing an embodiment of a machine learning algorithm operable with course learning objective prompts to generate course learning objectives and operable with course performance evaluation prompts to generate competency scores for each course learning objective along with supportive reasoning statements in an embodiment of the competency evaluation system.

FIG. 2B is a block diagram of a second computing device including a processor communicatively coupled to a non-transitory computer readable media containing an embodiment of a presentation program in an embodiment of the competency evaluation system.

FIG. 3 depicts an illustrative embodiment of a learner user graphical user interface implemented by operation of an embodiment of the presentation program of the competency evaluation system.

FIG. 4 is a block flow diagram of a method of generating and selecting course learning objectives and course learning criteria using an embodiment of the machine learning algorithm using learning objective prompts.

FIG. 5 depicts a first dialog box displayed on an administrator graphical user interface by an embodiment of the presentation program prompting an administrator user to enter course text content into course content text input window of a second dialog box.

FIG. 6 depicts a third dialog box displayed in an administrator graphical user interface by an embodiment of the presentation program prompting an administrator user to enter course learning objective prompts, which in particular embodiments includes zero shot prompts, into a prompt input window of a fourth dialog box.

FIG. 7 depicts an example of course learning objectives and course learning criteria generated by an embodiment of the machine learning algorithm using course learning objective prompts.

FIG. 8 depicts an example of course learning objectives and course learning criteria displayed by an embodiment of the presentation program in an administrator graphical user interface.

FIG. 9 depicts an example of administrator user selection of particular course learning objectives and course learning criteria by maintaining and removing check marks in check boxes displayed in an embodiment of an administrator graphical user interface.

FIG. 10 is a block flow diagram of a method of submitting learner user presentations to fulfil a course assignment and generating course competency scores for each course learning objective and each course learning criteria prior selected by a user administrator using an embodiment of the machine learning algorithm using course performance evaluation prompts.

FIG. 11 is an illustrative example of a presentation evaluation format generated by an embodiment of the machine learning algorithm using course performance evaluation prompts.

FIG. 12 is an example of a presentation evaluation of a learner user presentation evaluated by an embodiment of the machine learning algorithm using course performance evaluation prompts.

### V. DETAILED DESCRIPTION OF THE INVENTION

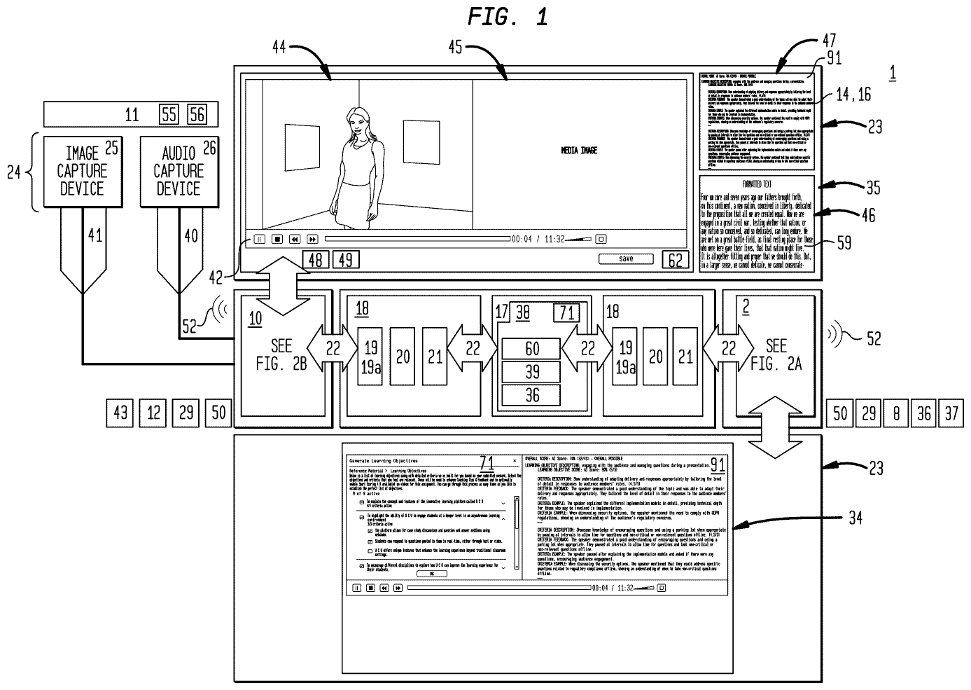

Now, with general reference to FIGS. 1 to 12, the present disclosure relates to a system (1) including one or more of: a first computing device (2) including a processor (3) communicatively coupled to a memory (4) containing a machine learning algorithm (5) using course learning objective prompts (6, 6a, 6b) configured to receive course text content (7) input by first computing device user (8) (also referred to as “an administrator user”). The machine learning algorithm (5) using prompts (6) analyzes the course text content (7) input by the administrator user (8) to generate one or more course learning objectives (9) from the course text content (7), and a second computing device (10) configured to record presentation content (11) produced by a second computing device user (12) (also referred to as a “learner user”). The first computing device (2) can be further configured to receive the presentation content (11) from the second computing device (10), and the machine learning algorithm (5) using presentation evaluation prompts (6, 6b) can further function to analyze presentation content text (13) in relation to the one or more course learning objectives (9) to generate a competency score (14) for each of the one or more course learning objectives (9) justified with one or more supportive reasoning statement(s) (15) and an overall presentation score (16).

Now, with primary reference to FIG. 1, in particular embodiments, one or more first computing device(s) (2) and one or more second computing devices (10) can each be configured to connect with one or more server computers (17) through a network (18) including one or more wide area networks (19) (“WAN”), such as the Internet (19a), or one or more local area networks (20), or cellular based network (21) to transfer corresponding content data (22). The one or more first computing devices (2) and the one or more second computing devices (10) can as to particular embodiments take the form of one or more corresponding limited-capability computers designed specifically for navigation on the World Wide Web of the Internet (19a). Alternatively, the one or more first computing devices (2) or the one or more second computing devices (10) can be a personal computing device, such as: desk top computing devices or hand-held computing devices, such as: smart phones, slate or pad computers, or camera/cell phones, or combinations thereof.

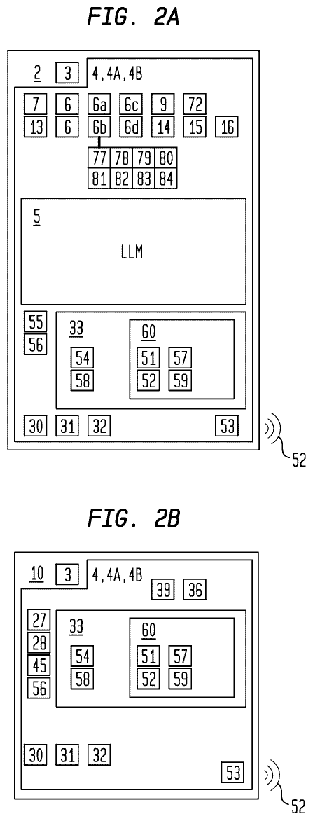

Now, with primary reference to FIGS. 1, 2A and 2B, each of the first computing device (2) and the second computing device (10) can include a display surface (23) which can be integral to or discrete from the first computing device (2) or the second computing device (10). In addition, each of the first computing device (2) and the second computing device (10) can further include peripheral input devices (24) such as an image capture device (25), as examples a camera, video camera, web camera, mobile phone camera, video phone, or the like, and an audio capture device (26) such as microphones, speaker phones, computer microphones, or the like. The audio capture device (26) can be provided separately from or integral with the image capture device (25). The image capture device (25) and the audio capture device (26) can be connected to the first computing device (10) or the second computing device (2) by an image capture interface (27) and an audio capture interface (28). The first computing device user (8) or the second computing device user (10) can enter user commands and information into a corresponding one of the first computing device (2) or the second computing device (10) through user input devices (29) such as a keyboard, a pointing device, display screen touch, or voice command; however, any method or device that converts user action into commands and information can be utilized.

Now, with primary reference to FIGS. 2A and 2B, the first computing device (2) and the second computing device (10) can each include a processor (3) communicatively coupled to a memory (4). The processor (3) can comprise one central-processing unit (CPU), or a plurality of processing units which operate in parallel to process digital information. The memory (4) can comprise a non-transitory computer readable medium. The memory (4) provides nonvolatile storage of computer-readable instructions, data structures, program modules and other data for the first computing device (2) and the second computing device (10). It can be appreciated by those skilled in the art that any type of computer-readable media that can store data that is accessible by a computer may be used in a variety of operating environments. The memory (4) can comprise a read only memory (ROM) (4A) and/or a random-access memory (RAM) (4B). A basic input/output system (BIOS) (30), containing routines that assist transfer of data between the components of the first or second computing device (3, 10), such as during start-up, can be stored in ROM (4A). The memory (4) of each of the first computing device (3) and the second computing device (10) can contain an operating system (31), one or more application programs (32), and a presentation program (33) (each to the extent not stored in a remote server (17)) which implements an administrator graphical user interface (34) for display on the display surface (23) of the first computing device (3) and a learner graphical user interface (35) for display on the display surface (23) of the second computing device (10) (as shown in the example of FIG. 1). The administrator and the learner graphical user interfaces (34, 35) can be implemented using various technologies and different devices, depending on the preferences of the designer and the particular efficiencies desired for a given circumstance.

Again, with primary reference to FIG. 1, in the context of distance education, correspondence education, or massive online open courses, an administrator user (8) can post one or more course assignments (36) for a course (37) in a server database (38). One or more learner user(s) (12) can access the server database (38) to download a course assignment (36) and the associated course resources (39). The term “assignment” means any task or work required of the learner user (12) which may include the production of presentation content (11) which can include one or more of: recording only an audio stream (40), recording only an image stream (41), media content (42), or text content (43), or combinations thereof (whether live or stored as a media file).

Again, with primary reference to FIGS. 1 through 3, the learner user (12) can activate the presentation program (33) to depict the learner graphical user interface (35) on the display surface (23) associated with the second computing device (10). The learner graphical user interface (34) can depict one or more of: a video display area (44), a media display area (45), a formatted text display area (46), competency score display area (47) and other display areas depending upon the embodiment of the presentation program (33). The learner graphical user interface (34) can further function to depict an image recorder selector (48) to select an image recorder (25) and depict an audio recorder selector (49) to select an audio recorder (26).

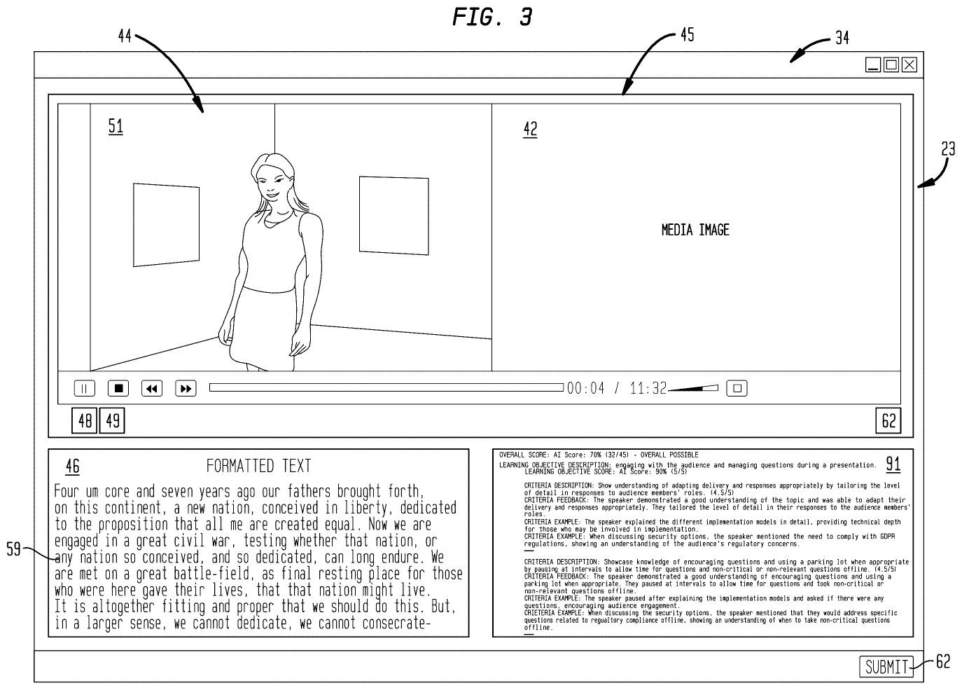

Again, with primary reference to FIGS. 1 through 3, in the production of presentation content (11) to satisfy a course assignment (36), the learner user (12) can activate the image recorder (25) and the audio recorder (26) by user command (50) to generate an image stream (41) and an audio stream (40) which can be processed by the presentation program (33) to display a video (51) in the video display area (44) and generate audio (52) from an audio player (53). In particular embodiments, the presentation program (33) can further include a transcription module (54) to analyze speech data (55) and word data (56) included in the presentation content (11). The transcription module (54) can further function to generate a presentation transcript (57). In particular embodiments, the presentation program (33) can include a formatter (58) which can depict formatted text (59) (as shown in the example of FIG. 3) of the presentation content (11) including all of the words in a presentation (60) in the formatted text display area (46) on a display surface (23) of second computing device (10). In particular embodiments the formatted text (59) can be depicted as fixed paragraphs within the formatted text display area (46). In particular embodiments, the formatted text (51) can be depicted as scrolled text within the formatted text display area (46). In particular embodiments, operation of the image capture device (25) or the audio capture device (26) can further activate a codec module (59) to compress the audio stream (40) or image stream (41) or the combined streams and retrievably store a presentation (60) in the server database (38) (or internal to the recorder (25, 26), the second computing device (10), the server computer (17) or other network node accessible by the second computing device (10)). In particular embodiments, the learner user interface (35) can further depict a submission element (62) which by user command (50) can allow access to the presentation (60) by the administrator user (8) of the first computing device (2).

Again, with primary reference to FIGS. 1 through 3, in particular embodiments, the first computing device (2) can access a machine learning algorithm (5) stored in the memory (4) of the first computing device (2), a server computer (17), or other network node. In a first step, the administrator user (8) of the first computing device (2), can use the machine learning algorithm (5) in a method to analyze the course text content (7) and generate one or more course learning objectives (9) from the course text content (7). In a second step, the administrator user (8) of the first computing device (2) can use the machine learning algorithm (5) in a method to analyze the presentation text (13) of the presentation transcript (57) of the presentation (60) submitted by the learner user (12) from the second computing device (10) in relation to each of the one or more course learning objectives (9) to generate a competency score (14) for each of the one or more course learning objectives (9) justified with one or more supportive reasoning statement(s) (15) and an overall presentation score (16).

The term “machine learning algorithm” means a large language model (LLM) using prompts (6) that allows the LLM to classify objects and provide detailed responses, and without limitation to the breadth of the foregoing, includes LLMs such as: Chat Generative Pre-trained Transformer (ChatGPT)®, including, but not necessarily limited to, GPT-3®, GPT-3.5®, and/or GPT-4®, available from OpenAI®.

The term “prompt” means a method of conditioning the LLM to provide guidance on the response content and the format of the response content. In particular embodiments, the LLM using prompts (6) can take the form of few-shot learning in which the LLM prompting includes a few examples (few-shot prompting (6d)), zero-shot learning in which the LLM prompting includes task specific prompts (zero-shot prompting (6c)), few-shot chain of thought learning, or zero-shot chain of thought learning in which few shot prompting or zero-shot prompting can further include step-by-step reasoning examples.

Accordingly, the invention can include a range of embodiments of the “machine learning algorithm” comprising different combinations of LLMs and prompting techniques each of which can be suitable to generate one or more course learning objectives (9) from the course text content (7) and to generate a competency score (14) for each of the one or more course learning objectives (9) justified with one or more supportive reasoning statement(s) (15) and an overall presentation score (16).

There can be a substantial advantage in using an LLM with zero-shot prompting (6a) to generate one or more course learning objectives (9) from course text contents (7) and to analyze presentation transcripts (57) of a plurality of presentations (60) submitted by learner users (12) to generate a competency score (14) for each of the one or more course learning objectives (9) justified with one or more supportive reasoning statement(s) (15) and an overall presentation score (16). In natural language processing models, zero-shot prompting (6a) means providing a prompt (6) that is not part of the training data that allows the LLM to classify objects from previously unseen classes, without receiving any specific training for those classes. In the context of education course work, where the course text content (7) can vary from course to course (37) and between administrator (8) to administrator (8), and where the learner presentation (60) submitted in response to the course assignment (36) can vary from learner (12) to learner (12), the LLM may not be able to classify different course text contents (7) into course learning objectives (9) since the course learning objectives (9) between a course A and a course B are not clear. Similarly, the LLM may not be able to classify the presentation transcript (57) in relation to different course learning objectives (9) because presentation content text (13) between learner user (12) presentation A and learner user (12) presentation B may not be clear.

However, in the context of generating course learning objectives (9) from course text content (7), even when the course text content (7) varies, it has been discovered that zero-shot prompting (6c) and/or few example prompting (6d) and/or variations thereof, allow the LLM to generate the desired result of generating course learning objectives (9) from course text content (7) without training or retraining the LLM to perform the task. With zero shot prompting, the zero-shot prompt (6c) includes simple instructions that include words or phrases that the LLM learned during training. This means that while the LLM probably cannot classify course content text (7) into category A or category B since the meaning of “A” and “B” are unclear, it can still classify the course content text (7) by topic because the LLM knows the meaning of the word “topic” and can differentiate between “topics” within the course content text (7). There is a substantial advantage in this approach because the LLM does not have to be trained or retrained to generate course learning objectives (9) for each course (37). Thus, providing a substantial cost and labor savings.

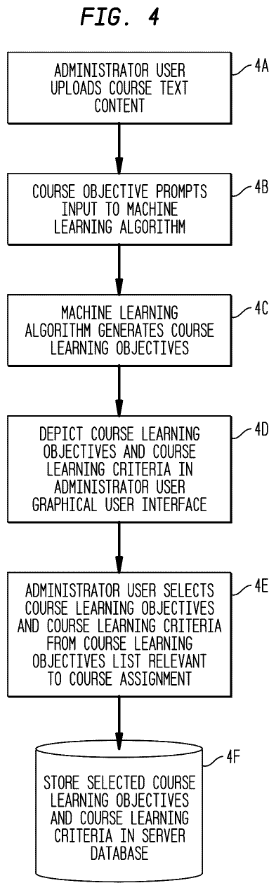

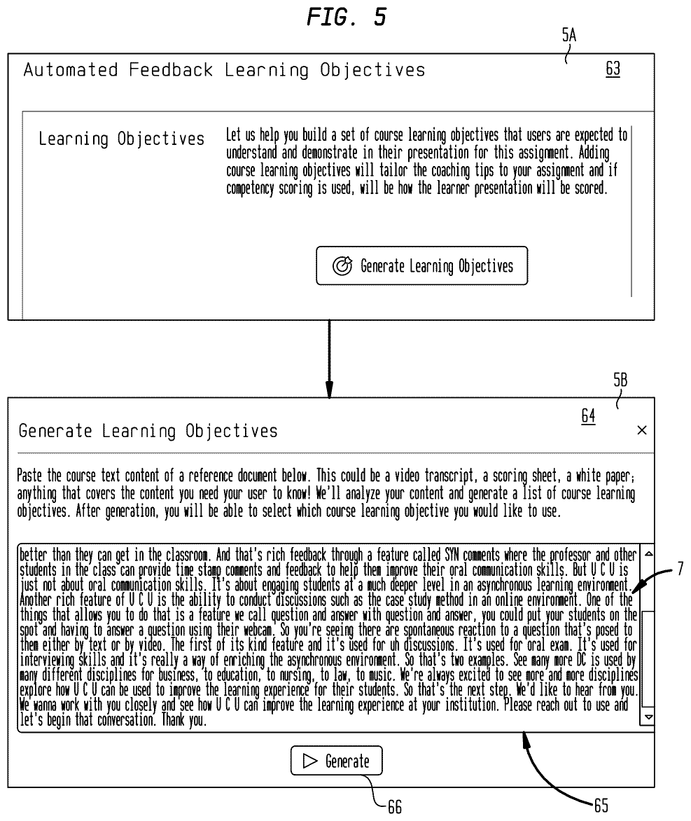

Now, with primary reference to FIG. 4, Block 4A and FIG. 5, the method to analyze the course text content (7) to generate one or more course learning objectives (9) from the course text content (7) can include uploading the course text content (7) for analysis by the machine learning algorithm (5). In particular embodiments, the machine learning algorithm (5) can use zero-shot prompting (6c). In the illustrative example of FIG. 5, Block 5A, the presentation program (33) can depict a first dialog box (63) to prompt the administrator user (8) in the administrator graphical user interface (34) for a user command (50) to activate the machine learning algorithm (5) (Automated Feedback—Generate Learning Objectives). The presentation program (33) can further function to depict a second dialog box (64) in the administrator graphical user interface (34) instructing the administrator user (8) to input course text content (7) into the course text content input window (65) (as shown in FIG. 5, Block 5B—Generate Learning Objectives). The administrator user (8) can input the course text content (7) into the course text content input window (65). The term “course text content” means any form of text content relevant to the course assignment (36) accessed by the learner user (12), and without limitation to the breadth of the foregoing, course text content (7) can include the text contained in one or more written or printed works, as examples: white papers, journal articles, video transcripts, paragraphs, HTML text, lists, and messages. The machine learning algorithm (5) can depict a course text content submit button (66) (as shown in FIG. 5, Block 5B—Generate).

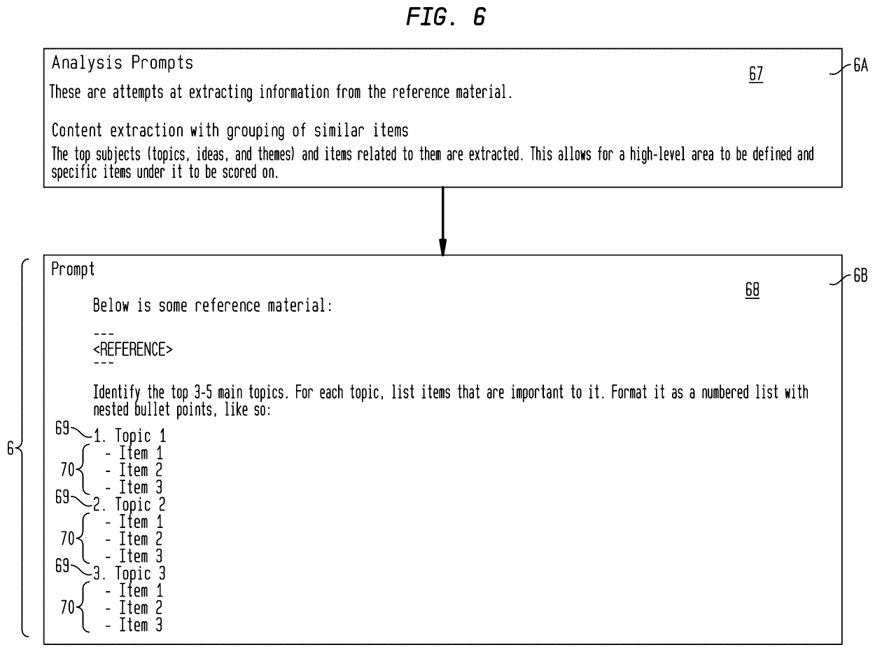

Now, with primary reference to FIG. 4, Block 4B and FIG. 6, in certain applications, the backend of the computer program code includes the appropriate prompts (6, 6a, 6c, 6d) for use by the machine learning algorithm (5); however, in particular applications, the method can further include operation of presentation program (33) to depict a third dialog box (67) in the administrator user interface (34) to instruct the administrator user (8) to prompt the machine learning algorithm (5) (as shown in the example of FIG. 6, Block 6A-Analysis Prompts). The method can further include operation of the presentation program (33) to depict a prompt input window (68) in which the administrator user (8) can input or edit one or more prompts (6, 6a, 6c, 6d). Whether the prompts (6, 6a, 6c, 6d) are included in the backend or entered by the administrator in the front end, the prompts (6, 6a, 6c, 6d) guide the machine learning algorithm (5) to extract main topics (69) (Topic 1, Topic 2, Topic 3 . . . . Topicₙ) and extract related items (70) from the course content text (7) and format extracted main topics (67) and extracted related items (70) in a list format (as shown in the illustrative example of FIG. 6, Block 6B.

In an illustrative example, where the LLM comprises Open AI GPT 3, the prompt can take the form of:

Below is some reference material:
---
<REFERENCE>
---
Identify the top 3-5 main topics.
For each topic, list items that are important to it. Format it as a numbered list with nested bullet points, like so:
1. Topic 1
   Item 1
   Item 2
   Item 3
2. Topic 2
   Item 1
   Item 2
   Item 3
3. Topic 3
   Item 1
   Item 2
   Item 3

This example is not intended to limit embodiments of the invention to a particular large language model (LLM) or format as to the recitation or number of prompts (6, 6a, 6b); rather this example is intended to provide sufficient information to a person of ordinary skill to allow the use of a wide variety of LLMs with prompts (6), and in certain embodiments, a zero-shot technique using one or more prompts (6, 6a, 6c, 6d) effective to generate course learning objectives (9) based on the input course text content (7).

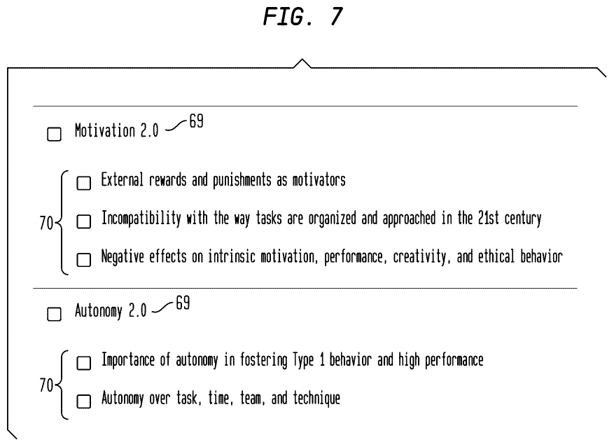

Now, with primary reference to FIG. 4, Block 4C and FIG. 7, the administrator user (8) having input the course content text (7), and in certain applications the prompts (6, 6a or 6b), the method can further include, operating the machine learning algorithm (5) using prompts (6) to extract main topics (69) and a subset of related items (70). In the illustrative example of FIG. 7, the extracted main topics (69) (in the example of FIG. 7 Motivation, Autonomy . . . ) are each followed by a subset of related items (70).

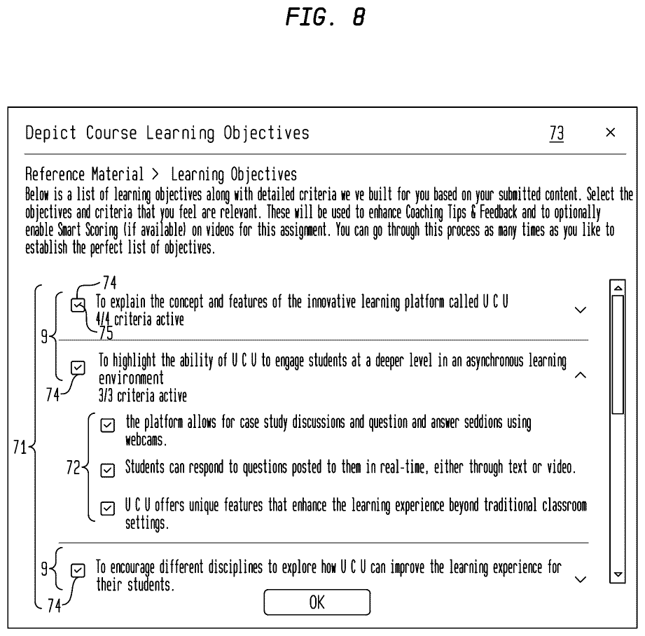

Now, with primary reference to FIG. 4, Block 4D and FIG. 8, the method can further comprise operating the presentation program (33) to depict a fourth dialog box (73) including a course learning objectives list (71) in the administrator user graphical user interface (34) on the display surface (23) of the first computing device (3). In the illustrative example of FIG. 8, the course learning objectives list (71) includes course learning objectives (9) and course learning criteria (72). Each course learning objective (9) and each of the course learning criteria (72) can be associated with a check box (74). The administrator user (8) can interact with each check box (74) to maintain a check mark (75) to indicate that the course learning objective (9) or course learning objective criteria (72) is retained or remove a check mark (75) to indicate that the course learning objective (9) or the course learning criteria (72) is removed. Only the course learning objectives (9) and course learning criteria (72) retained will be utilized in subsequent scoring of a learner (12) submitted presentation (60). This illustrative example is not intended to preclude the use of different display formats to present the course learning objectives (9) or the course learning criteria (72) and is not intended to preclude the use of other forms of user interactive elements to maintain or remove course learning objectives (9) or course learning criteria (72) and can be implemented using various technologies and different devices, depending on the preferences of the designer and the particular efficiencies desired for a given circumstance.

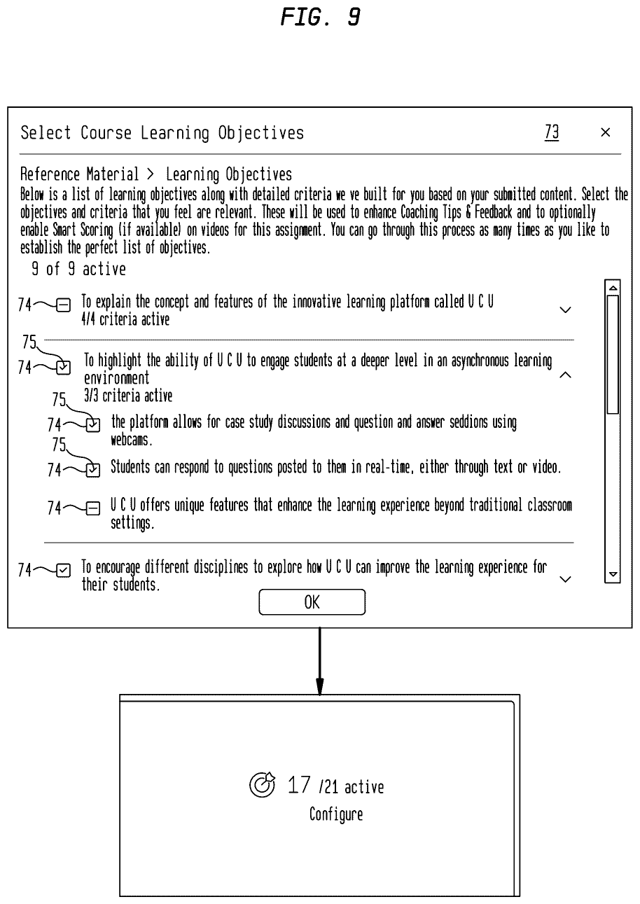

Again, with primary reference to FIG. 4, Block 4E and FIG. 9, in particular embodiments, the method can further include selecting course learning objectives (9) and course learning criteria (72) to be retained for subsequent scoring of student presentations (60) submitted to the administrator user (8). In the example of FIG. 9, the administrator user (8) has interacted with the check boxes (74) to remove certain check marks (75) to remove certain course learning objectives (9) and certain course learning criteria (72). The method can further include administrator user interacting with a submit button (in the example of FIG. 9 an “OK” button) to active the machine learning algorithm (5) to configure the remaining course learning objectives (9) and course learning criteria (72) for subsequent scoring of student submitted presentations (60).

Now, with primary reference to FIG. 4, Block 4F, the method can further include storing the learning objectives list (71) in one more of the second computing device (10), the server computer (17), or another network node, accessible by the second computing device (10).

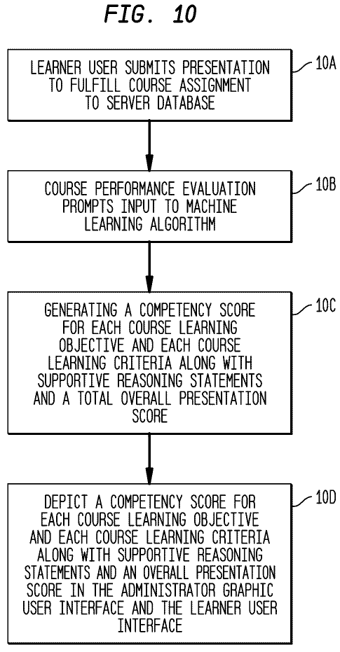

Now, with primary reference to FIGS. 10, Block 10A, and FIG. 1, in particular embodiments, the method can further include submitting the presentation (60) by learner user (12) interaction with the submission element (62) in the learner user graphical user interface (35) of the second computing device (10) to allow access to the presentation (60) by the administrator user (8) of the first computing device (3) and scoring by operation of the machine learning algorithm (5). In a population of learner users (12) submitting a presentation (60) to fulfill the same course assignment (36), each presentation (60) can afford a different presentation transcript (57) which can all be evaluated by the machine learning algorithm (5) using prompts (6) without further training or retraining of the LLM.

Now, with primary reference to FIG. 10, Block 10B, and FIG. 2, in particular embodiments, the method can further include a machine learning algorithm (5) using course performance evaluation prompts (6, 6b, 6c, 6d) to generate a competency score (14) for each course learning objective (9) and each course learning criteria (72) prior selected by the administrator user (8) and an overall presentation score (16). In particular embodiments, the course performance evaluation prompts (6, 6b, 6c, 6d) allow the machine learning algorithm (5) to generate supportive reasoning statements (15) to justify each competency score (14) and the overall presentation score (16).

Now, with primary reference to FIG. 10, Block 10B and FIG. 2, in the following illustrative example, using Open AI® GPT 3®, the course performance evaluation prompts (6, 6b, 6c, 6d) can include one or more of the following components: an introduction component (77) to provide high-level information about the task the machine learning algorithm (5) will perform; a guidance component (78) to steer the machine learning algorithm (5) to respond with a particular style and behavior and specifically with attributes such as verbosity, tone, personality, and strictness; a formatting component (79) to provide a formal specification of the output from the machine learning algorithm (5), for example, the formal specification can be in JavaScript Object Notation (JSON schema), wherein the machine learning algorithm (5) should then produce a JSON document formatted to match the formal specification; a presentation transcript text component (80) produced by transcribing the presentation (60) submitted by the learner user (12), to provide presentation transcript text (81) (for example a transcript of an audio stream (40)); a learning objectives component (82) comprising a textual representation of the course learning objectives (9) including the text of the course learning objectives (9) and the text of the course learning criteria (72); and an instructions component (83) including an evaluation task instruction directing the machine learning algorithm (5) to the presentation transcript text (81), the course learning objectives (9), and course learning criteria (72).

For all presentation evaluations, the introduction component (77), the guidance component (78), the formatting component (79), and instructions component (83) can remain relatively static. The presentation transcript text component (80) differs between the presentation transcript text (82) of each submitted presentation (60). The learning objectives component (82) remains the same for every evaluated presentation transcript text (81) within a learner user (12) population fulfilling the course learning objectives (9) and course learning criterial (72) for the same course assignment (36). The structure of the learning objectives component (9) can group the learning objectives (9) and course learning criteria (72) by category which can be inserted as batches into the evaluation prompt (76). This can result in one or more learning objectives component prompt (76) per category of learning objectives (9). The advantage of grouping the learning objectives (9) by category focuses the machine learning algorithm (5) on a theme to evaluate, thus reducing complexity. However, additional course performance evaluation prompts (6, 6b, 6c, 6d) can be used if the length of the prompt exceeds the algorithm's token limit or complexity.

An illustrative example of an evaluation prompt (76) identifying each evaluation prompt component, follows:

### Introduction Component (77).

You are an assistant to an educator. The educator will give you a transcript of a presentation from a student speaker. After the transcript the educator will provide criteria that the speaker is evaluated on. Your task is to review the presentation via the transcript and assess it based on criteria. It is crucial that you are accurate, detailed, and thorough in your explanations. Think through each criteria step by step and give your assessment.

### Guidance Component (78).

The following are topics that should have been discussed in the presentation. Based on the transcript, assess how well the speaker understood the topic. Explain why and how the speaker demonstrated and applied their knowledge. Give quotes from the transcript directly related to your assessment. Then give a score from 0 (the topic wasn't mentioned) to 5 (the topic was thoroughly discussed). If you give a score below 5, explain in your assessment what the speaker could have done to improve their score.

### Transcription Component (80).

Below is a transcript of a speech:
---
<TRANSCRIPT>

### Formatting Component (79).

The JSON schema specification is:

```
{
  “type”: “object”,
  “properties”: {
    “criteria”: {
      “type”: “array”,
      “description”: “List of evaluation feedback for all criteria”,
      “items”: {
        “type”: “object”,
        “properties”: {
          “id”: {
            “type”: “string”,
            “description”: “ID of the criteria being evaluated, e.g. 2c”
          },
          “quotes”: {
            “type”: “array”,
            “description”: “List of quotes from the transcript that support the score and
explanation”,
            “minItems”: 0,
            “items”: {
              “type”: “string”
            }
          },
          “explanation”: {
            “type”: “string”,
              “description”: “Brief, 1 to 2 sentences explaining the coverage, or lack thereof of
the criteria”
          },
          “score”: {
            “type”: “number”,
            “description”: “Score given in points from 0 to 5”,
            “minimum”: 0,
            “maximum”: 5
          }
        },
        “required”: [
          “id”,
          “quotes”,
          “explanation”,
          “score”
        ]
      }
    }
  },
  “required”: [
    “criteria”
  ]
}
```

### Learning Objective Component (82):

1. Understand the process of making classic chocolate chip cookies.
1a. Identify the key ingredients and their measurements, such as butter, granulated sugar, light brown sugar, all-purpose flour, corn starch, baking soda, salt, chocolate chips, and chopped toasted pecans.
1b. Explain the importance of creaming the butter and sugar together to lend structure to the cookie dough.
1c. Describe the role of adding an egg and vanilla to the dough.
1d. Discuss the significance of adding corn starch to ensure softness in the center of the cookies.
1e. Demonstrate the proper technique of combining the dry ingredients with the wet ingredients to create the cookie dough.
2. Techniques for making chocolate chip cookies.
2a. Discuss the process of blending the dry ingredients into the dough until well combined.
2b. Explain the technique of scooping and rolling the dough into balls before baking.
2c. Discuss the impact of room temperature butter on the cookies' spreading or holding their shape.
2d. Identify the benefits of chilling the dough in the fridge before baking.
2e. Explain the option of freezing pre-shaped cookie dough for future use.
3. Analyze the characteristics of well-made chocolate chip cookies.
3a. Identify the desired texture of the cookies, with a crispy outside and chewy inside.
3b. Recognize the importance of evenly distributed chocolate chips and pecans throughout the dough.
3c. Discuss the significance of allowing the cookies to cool on the tray to set up before removing them.
3d. Evaluate the appearance of the cookies, aiming for a golden brown color around the edges.
3e. Demonstrate the ability to assess the quality of the cookies based on their taste and texture.

### Instruction Component (83).

Evaluate all criteria—1a through 3e.
Each criteria is prefixed with its ID. The IDs are 1a through 3e.

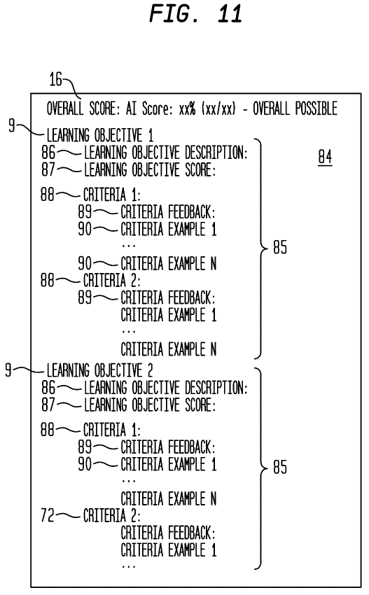

Now, with primary reference to FIG. 10, Block 10B and FIG. 11, based on the formatting component (79) of the course performance evaluation prompt (76), the method can further include generating a presentation evaluation format (84) for evaluation of the presentation text (13) and generation of the competency score (14) and the overall presentation score (16) with supportive reasoning statements (15). In the illustrative example of FIG. 11, the presentation evaluation format (84) generated by the machine learning algorithm (5) includes an overall presentation score (16) followed by one or more learning objectives groups (85) each including a learning objective description (86) with a competence score value (87) followed by one or more learning criteria descriptions (88) and supportive reasoning statements (15) in the form of course learning feedback (89) comprising machine learning reasoning explaining the evaluation of each learning criteria (72) and course criteria examples (90) including verbatim text extracts from the transcript text (81). The overall presentation score (16) for a learning objective (9) is computed from the competency scores (14) of the course learning criteria (72).

Now, with primary reference to FIG. 10, Block 10 C and FIG. 11, the method can further include scoring by the machine learning algorithm (5). Based on the course performance evaluation prompt (6, 6b, 6c, 6d) the machine learning algorithm (5) can generate a competency score (14) for each a plurality of course learning criteria (72) in the range of 0 to 5. In particular embodiments, the method can further include adjusting the competency score (14) generated by the machine learning algorithm (5) to reduce variance between manual administrator scoring and machine scoring. For instance, the machine learning algorithm (5) might give 4 points out of 5 points for a course learning criterion (72) where manual scoring by the administrator (8) might give 5 points out of 5 points for the same course learning criterion.

In particular embodiments, a ternary system can be used to adjust scoring by the machine learning algorithm (5). Under an embodiment of the ternary system, to compute the competency score (14) for a learning objective (9), the scoring range 0 through 5 can be allocated into three parts, each with a scoring range of two competency score values. The machine learning algorithm (5), then awards no points, half a point, or a full point to each course learning criteria (72) based on where the machine learning algorithm (5) scored the course learning criteria (72). For example:
between 0 and 1 points—no points
between 2 and 3 points—a half a point
between 4 and 5 points—a full point

The ternary system can be utilized on a greater scoring range, for example 0 through 10 in which points can be allocated, as follows:
between 0 and 3 points—no points
between 4 and 7 points—a half a point
between 8 and 10 points—a full point

In particular embodiments, the machine learning algorithm (5) can perform multiple evaluations of the learner user's (12) submitted presentation (6). Initially, two evaluations can be performed. The competency score values (87) for corresponding course learning objectives (9) can be compared between the evaluations. If the competency score values (87) differ by a pre-specified threshold, then a third evaluation can be performed. With three evaluations, a consensus can be reached, wherein the competency score (14) is determined. The order of course learning objectives (9) and course learning criteria (72) can be shuffled (reordered) in the prompts (6) between evaluations. The purpose of this is to reduce variance between two similar submissions and acquire a more accurate evaluation.

Depending on the results of each evaluation, an outlier may be ignored and a combination of similarly clustered results can be used. This may involve combining scores using the median, average, or maximum, whichever is appropriate. The justification and examples (quotes) from the evaluation result closest to the final competency score values (87) (reached through consensus) can be presented to the administrator users (8) and the learner users (12) and the others discarded.

To assess and refine the consensus generating LLM over zero shot and few shot prompting, the LLM may be “seeded.” When the same seed is presented, the same output should be produced for identical input. Conversely, a different seed will likely produce a different output. As an illustrative example, OpenAI®'s ChatGPT® is non-deterministic, that is, given the same input (prompt) it may generate a different output. By running multiple evaluations with non-deterministic output (or different seeds), this can effectively be thought of as having multiple human evaluators reviewing the same learner user presentation (6) independently of each other. Expanding on that idea, different LLMs can be used to cross-check evaluation results to ensure consistency and reduce factual inaccuracies (aka hallucinations).

In the next step, the method can include summing the points awarded for each course learning criteria (72) of a course learning objective (9). For example, for a course learning objective (9) having four course learning criteria (72):
Learning Criteria A-ML gave 4/5—Award a point
Learning Criteria B-ML gave 0/5—Award no points
Learning Criteria C-ML gave 2/3—Award half a point
Learning Criteria D-ML gave 3/5—Award half a point

The sum of the total awarded points: two points (addends being: 1+0+0.5+0.5).

In the next step, the method can further include scaling the awarded points to the point scale for the corresponding learning objective (9). In the instant example, the point scale is five points and the possible points that could have been awarded is four points. The awarded points for Learning Criteria A-D in the example is two points. Two points awarded of the possible four points that could have been awarded is 50%. When scaled to the five point scale the awarded points equals 2.5 points out of 5 points. In particular embodiments, the machine learning algorithm (5) can further operate to round the scaled score of 2.5 to the nearest point integer 3 points. The method can include summing the awarded points for each learning objective (9) to provide the overall presentation score (16).

The above example is not intended to preclude other embodiments of a presentation evaluation format (84) and/or method of scoring presentations (60), presentation content (11), presentation text (13), or transcript text (81) whether in whole or in part which may be used in combination with embodiments of the method to generate course learning objectives (9) and/or course learning criteria (72).

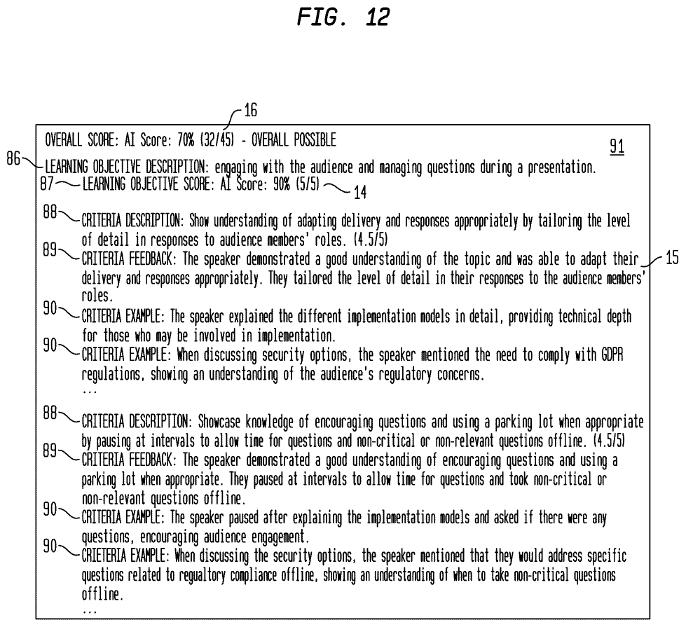

Now, with primary reference to FIG. 10, Block 10D and FIG. 12, the method can further include depicting a presentation evaluation (91) in one or both of the administrator graphical user interface (34) and the learner user graphical user interface (35). In the example of FIG. 12, the presentation evaluation (91) takes the general form of the evaluation format (84) shown in FIG. 11 in which the overall presentation score (16) is followed one or more learning objective groups (85) each including one or more learning objective descriptions (86) followed by one or more course learning criteria descriptions (88) including a competency score (14) justified by supportive reasoning statements (15) in the form of course learning feedback (89) comprising machine learning reasoning explaining the evaluation of each learning criteria (72) and course criteria examples (90) which can include verbatim text extracts from the transcript text (81).

Now, with primary reference to Table I below which summarizes the results of a comparison of a manual score of Learner Presentations (Examples 1 through 21) to Machine Learning Scoring by an embodiment of the invention in accordance with the above-described method as a score variance.

TABLE I
Comparison of Manual Scoring to Machine
Scoring -- Score Variance.

| Learner | | Machine Learning | Score |
|---|---|---|---|
| Presentation | Manual Score | Score | Variance % |
| Example 1 | 18.8/20 | 13/15 | 7.33% |
| Example 2 | 20/20 | 15/15 | 0.00% |
| Example 3 | 20/20 | 15/15 | 0.00% |
| Example 4 | 20/20 | 13/15 | 13.33% |
| Example 5 | 20/20 | 13/15 | 13.33% |
| Example 6 | 20/20 | 15/15 | 0.00% |
| Example 7 | 19.6/20 | 13/15 | 11.33% |
| Example 8 | 20/20 | 15/15 | 0.00% |
| Example 9 | 17.6/20 | 13/15 | 1.33% |
| Example 10 | 20/20 | 15/15 | 0.00% |
| Example 11 | 18.8/20 | 15/15 | −6.00% |
| Example 12 | 20/20 | 15/15 | 0.00% |
| Example 13 | 20/20 | 13/15 | 13.33% |
| Example 14 | 20/20 | 15/15 | 0.00% |
| Example 15 | 20/20 | 15/15 | 0.00% |
| Example 16 | 20/20 | 13/15 | 13.33% |
| Example 17 | 20/20 | 15/15 | 0.00% |
| Example 18 | 20/20 | 13/15 | 13.33% |
| Example 19 | 20/20 | 15/15 | 0.00% |
| Example 20 | 19.6/20 | 13/15 | 11.33% |
| Example 21 | 20/20 | 15/15 | 0.00% |

The results indicate that the score variance based on the comparison between manual scoring by an administrator (8) and automated machine learning scoring of learner (12) submitted presentations (60) on average is about 4.83%. The results evidence the suitability of an LLM with task specific learning objectives prompting (6, 6a, 6b) in accordance with the inventive method to generate course learning objectives (9) and course learning criteria (72) for administrative users (8), and in particular embodiments, the suitability of an LLM with task specific evaluation prompting (76) in accordance with the inventive method to evaluate learner (12) submitted presentations (60) and generate competency scores (14) for each course learning criteria (72) along with supportive reasoning statements (15) to justify the competency scores (14) and further generate and overall presentation score (16).

As can be easily understood from the foregoing, the basic concepts of the present invention may be embodied in a variety of ways. The invention involves numerous and varied embodiments of a competency evaluation system (1) and methods for making and using such a competency evaluation system (1) including the best mode.

As such, the particular embodiments or elements of the invention disclosed by the description or shown in the figures or tables accompanying this application are not intended to be limiting, but rather exemplary of the numerous and varied embodiments generically encompassed by the invention or equivalents encompassed with respect to any particular element thereof. In addition, the specific description of a single embodiment or element of the invention may not explicitly describe all embodiments or elements possible; many alternatives are implicitly disclosed by the description and figures.

It should be understood that each element of an apparatus or each step of a method may be described by an apparatus term or method term. Such terms can be substituted where desired to make explicit the implicitly broad coverage to which this invention is entitled. As but one example, it should be understood that all steps of a method may be disclosed as an action, a means for taking that action, or as an element which causes that action. Similarly, each element of an apparatus may be disclosed as the physical element or the action which that physical element facilitates. As but one example, the disclosure of a “score” should be understood to encompass disclosure of the act of “scoring”—whether explicitly discussed or not—and, conversely, were there is a disclosure of the act of “scoring”, such a disclosure should be understood to encompass disclosure of a “score” and even a “means for scoring”. Such alternative terms for each element or step are to be understood to be explicitly included in the description.

In addition, as to each term used it should be understood that unless its utilization in this application is inconsistent with such interpretation, common dictionary definitions should be understood to be included in the description for each term as contained in the Random House Webster's Unabridged Dictionary, second edition, each definition hereby incorporated by reference.

All numeric values herein are assumed to be modified by the term “about”, whether or not explicitly indicated. For the purposes of the present invention, ranges may be expressed as from “about” one particular value to “about” another particular value. When such a range is expressed, another embodiment includes from the one particular value to the other particular value. The recitation of numerical ranges by endpoints includes all the numeric values subsumed within that range. A numerical range of one to five includes for example the numeric values 1, 1.5, 2, 2.75, 3, 3.80, 4, 5, and so forth. It will be further understood that the endpoints of each of the ranges are significant both in relation to the other endpoint, and independently of the other endpoint. When a value is expressed as an approximation by use of the antecedent “about,” it will be understood that the particular value forms another embodiment. The term “about” generally refers to a range of numeric values that one of skill in the art would consider equivalent to the recited numeric value or having the same function or result. Similarly, the antecedent “substantially” means largely, but not wholly, the same form, manner or degree and the particular element will have a range of configurations as a person of ordinary skill in the art would consider as having the same function or result. When a particular element is expressed as an approximation by use of the antecedent “substantially,” it will be understood that the particular element forms another embodiment.

Moreover, for the purposes of the present invention, the term “a” or “an” entity refers to one or more of that entity unless otherwise limited. As such, the terms “a” or “an”, “one or more” and “at least one” can be used interchangeably herein.

Further, for the purposes of the present invention, the term “coupled” or derivatives thereof can mean indirectly coupled, coupled, directly coupled, connected, directly connected, or integrated with, depending upon the embodiment.

Additionally, for the purposes of the present invention, the term “integrated” when referring to two or more components means that the components (i) can be united to provide a one-piece construct, a monolithic construct, or a unified whole, or (ii) can be formed as a one-piece construct, a monolithic construct, or a unified whole. Said another way, the components can be integrally formed, meaning connected together so as to make up a single complete piece or unit, or so as to work together as a single complete piece or unit, and so as to be incapable of being easily dismantled without destroying the integrity of the piece or unit.

Thus, the applicant(s) should be understood to claim at least: i) each of the a competency evaluation system herein disclosed and described, ii) the related methods disclosed and described, iii) similar, equivalent, and even implicit variations of each of these devices and methods, iv) those alternative embodiments which accomplish each of the functions shown, disclosed, or described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) methods and apparatuses substantially as described hereinbefore and with reference to any of the accompanying examples, x) the various combinations and permutations of each of the previous elements disclosed.

The background section of this patent application, if any, provides a statement of the field of endeavor to which the invention pertains. This section may also incorporate or contain paraphrasing of certain United States patents, patent applications, publications, or subject matter of the claimed invention useful in relating information, problems, or concerns about the state of technology to which the invention is drawn toward. It is not intended that any United States patent, patent application, publication, statement or other information cited or incorporated herein be interpreted, construed or deemed to be admitted as prior art with respect to the invention.

The claims set forth in this specification, if any, are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent application or continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon. The elements following an open transitional phrase such as “comprising” may in the alternative be claimed with a closed transitional phrase such as “consisting essentially of” or “consisting of” whether or not explicitly indicated the description portion of the specification.

Additionally, the claims set forth in this specification, if any, are further intended to describe the metes and bounds of a limited number of the preferred embodiments of the invention and are not to be construed as the broadest embodiment of the invention or a complete listing of embodiments of the invention that may be claimed. The applicant does not waive any right to develop further claims based upon the description set forth above as a part of any continuation, division, or continuation-in-part, or similar application.

1. A method, comprising:
analyzing course text content of a course by a machine learning algorithm including a large language model using course learning objective prompts;
automatically generating course learning objectives and course learning criteria for said course based on said analyzing of said course text content by said large language model using said course learning objective prompts;
depicting said course learning objectives and said course learning criteria in a course learning objectives list on a display surface of a computing device,
wherein each course learning objective and each course learning criteria within said course learning objective list associated with a course learning objective selection element;
selecting said course learning objectives and said course learning criteria for said course by user interaction with said course learning objective selection element; and
wherein each selected course learning objective and said course learning criteria used by said machine learning algorithm including said large language model to evaluate submitted course presentation text of a presentation using course evaluation prompts.

2. The method of claim 1, wherein said large language model is selected from the group of large language models consisting of: ChatGPT®, GPT-3®, GPT-3.5®, and GPT-4®.

3. The method of claim 1, wherein said task specific course learning objectives prompts comprise one or more of: a zero-shot prompt, a few-shot prompt, and a few-shot chain of thought prompt.

4. The method of claim 1, wherein said task specific course learning objective prompts comprise one or more of a zero shot prompt.

5. The method of claim 1, wherein selecting said course learning objectives and said course learning criteria for said course by user interaction with said course learning objective selection element alters said course learning objectives or said course learning criteria automatically generated by said large language model using said task specific course learning objective prompts.

6. The method of claim 1, further comprising:
depicting on said display surface of said computing device a course text content input window; and
inputting said course text content of a course into said a course text content input window.

7. The method of claim 1, wherein said course learning objectives prompts guide said machine learning algorithm to extract one or more main topics from said course text content of a course input into said course text content input window.

8. The method of claim 7, further comprising:
depicting on said display surface of said computing device a prompt input window; and
inputting, by user interaction, one or more course learning objectives prompts into said prompt input window.

9. The method of claim 8, wherein said task specific course learning objectives prompts instruct said machine learning algorithm to depict said one or more main topics on said display surface of said computing device in a topic list format, wherein said topic list format includes each main topic extracted from said course text content followed by one or more course learning criteria extracted from said course text content.

10. The method of claim 1, further comprising:
evaluating presentation text of a presentation by said machine learning algorithm using task specific performance evaluation prompts, wherein evaluating presentation text comprises identifying relationships between said presentation text and said prior generated course learning objectives and prior generated course learning criteria;
automatically generating a competency score by said machine learning algorithm using said task specific performance evaluation prompts based on the level of the identified relationships between said presentation text and each of said course learning objectives and each of said course learning criteria prior generated by said machine learning algorithm using said task specific course learning objective prompts;
automatically generating supportive reasoning statements by said machine learning algorithm using said task specific performance evaluation prompt for each course learning objective and each course learning criteria;
depicting a presentation evaluation on a display surface of said first computing device,
wherein said presentation evaluation depicts said course learning objectives and said course learning criteria each associated with said competency score,
wherein said presentation evaluation depicts said supportive reasoning statements associated with each course learning criteria.

11. The method of claim 10, wherein said task specific performance evaluation prompts includes a transcription component prompt including said presentation text of said presentation.

12. The method of claim 10, wherein said task specific performance evaluation prompts include a course learning objectives prompt and a course learning criteria prompt including prior generated course learning objectives and course learning criteria.

13. The method of claim 10, wherein said task specific performance evaluation prompts include an instruction prompt instructs said machine learning algorithm to score identified relationships between said presentation text and each of said course learning objectives and each of said course learning criteria with competency score value within a numerical range.

14. The method of claim 10, wherein said task specific performance evaluation prompts instructs said machine learning algorithm to generate supportive reasoning statements for each course learning criteria.

15. The method of claim 14, wherein said supportive reasoning statements include machine learning reasoning by said machine learning algorithm explaining identified relationships between said presentation text and each of said course learning objectives and each of said course learning criteria.

16. The method of claim 14, where said supportive reasoning statements include verbatim text extracts as examples of said identified relationships between said presentation text and each of said course learning objectives and each of said course learning criteria.

17. The method of claim 10, wherein said task specific performance evaluation prompts includes a formatting prompt to provide a formal specification of the output from the machine learning algorithm.

18. The method of claim 10, further comprising adjusting competency scores generated by said machine learning algorithm to reduce variance between manual scoring and machine scoring using a consensus algorithm.

19. A non-transitory computer readable medium encoded with a machine learning algorithm that, when executed, cause a system to perform actions to depict course learning objectives and course learning criteria, the actions comprising:
analyzing course text content of a course by said machine learning algorithm including a large language model using task specific course learning objective prompts;
automatically generating course learning objectives and course learning criteria for said course based on said analyzing of said course text content by said large language model using said task specific course learning objective prompts;
depicting said course learning objectives and said course learning criteria in a course learning objectives list on a display surface of a computing device,
wherein each course learning objective and each course learning criteria within said course learning objective list associated with a course learning objective selection element; and
receiving, by user interaction with said course learning objective selection element, selection of said course learning objectives and said course learning criteria for said course.

20. The non-transitory computer readable medium of claim 19, wherein said large language model using task specific course learning objective prompts does not require training or re-training to generate course learning objectives and course learning criteria for course text content associated with different courses.

21. The non-transitory computer readable medium of claim 20, wherein said task specific course learning objective prompts comprise zero shot prompts.

22. The non-transitory computer readable medium of claim 21, wherein said course text content comprises a transcription of oral or written words, an essay, an article, a dissertation, a manuscript, a paper, a thesis, a treatise, an exposition, a composition, or combinations thereof.

23. The non-transitory computer readable medium of claim 19, wherein depicting said course learning objectives and course learning criteria, further comprises manual selection of said course learning objectives and course learning criteria, wherein manual selection which alters said course learning objectives and said course learning criteria of a course.

24. A non-transitory computer readable medium encoded with a machine learning algorithm that, when executed, cause a system to perform actions to depict course learning objectives and course learning criteria, the actions comprising:
evaluating presentation text of a presentation by said machine learning algorithm using task specific performance evaluation prompts, wherein evaluating presentation text comprises identifying relationships between said presentation text and said prior generated course learning objectives and prior generated course learning criteria;
automatically generating a competency score by said machine learning algorithm using said task specific performance evaluation prompts based on the level of the identified relationships between said presentation text and each of said course learning objectives and each of said course learning criteria prior generated by said machine learning algorithm using said task specific course learning objective prompts;
automatically generating supportive reasoning statements by said machine learning algorithm using said task specific performance evaluation prompt for each course learning objective and each course learning criteria;
depicting a presentation evaluation on a display surface of said first computing device,
wherein said presentation evaluation depicts said course learning objectives and said course learning criteria each associated with said competency score,
wherein said presentation evaluation depicts said supportive reasoning statements associated with each course learning criteria.
